(19) United States
(12) Patent Application Publication
(10) Pub. No.: US 2008/0151980 A1
(43) Pub. Date: Jun. 26, 2008

(54) METHOD OF AND APPARATUS FOR ADAPTIVE FREQUENCY ERROR ESTIMATION

(76) Inventors: Bengt Lindoff, Bjarred (SE); Bo Bernhardsson, Lund (SE); Johan Nilsson, Hollviken (SE)

Correspondence Address: ERICSSON INC., 6300 LEGACY DRIVE, M/S EVR 1-C-11, PLANO, TX, 75024, US

(21) Appl. No.: 11/615,877

(22) Filed: Dec. 22, 2006

(51) Int. Cl. H04B 17/00; H04B 3/46

(52) U.S. Cl. 375/226

(57) ABSTRACT

A method and apparatus that adapts, from time to time, a frequency error estimation algorithm between a cyclic prefic (CP) correlation algorithm and pilot symbols algorithm depending on the values of several variables, including service (VoIP/high data rate), signal to noise ratio (SNR), Doppler spread, system BW, and whether the system is time division duplex (TDD) or frequency division duplex (FDD). The method and apparatus is also adapted to select both algorithms.

### BACKGROUND

The present invention relates to cellular communication networks. More particularly, and not by way of limitation, the present invention is directed to an apparatus and method adapted to determine which, of a plurality of automatic frequency correction algorithms, to use during communication between a user equipment (UE) and cell.

In the evolution of mobile cellular communication standards such as Global System for Mobile Communication (GSM) and Wideband Code Division Multiple Access (WCDMA), new modulation techniques such as Orthogonal Frequency Division Multiplexing (OFDM) are likely to be implemented. In order to transition the existing cellular communication systems to the new high capacity, high data rate system in the existing radio spectrum, a new system able to operate on a flexible bandwidth (BW) is required. One such flexible cellular system is known as 3^{rd} Generation (3G) Partnership Project Long Term Evolution (3G LTE). 3G LTE is an evolution of the 3G WCDMA standard. 3G LTE will likely use OFDM and operate on BWs spanning from 1.25 MHz to 20 MHz.

It is anticipated that 3G LTE will facilitate data rates up to 100 megabits per second (Mb/s), however, low data rate services, such as voice telephony, will also be used in 3G LTE systems. Because 3G LTE has been designed using the transmission control protocol/internet protocol (TCP/IP), packet based voice over IP (VoIP) will be the service that carries speech. One power saving technique that can be used with VoIP, in a manner similar to that used by GSM systems, is discontinuous reception/discontinuous transmission (DRX/DTX). DRX/DTX turns the receiver and transmitter on and off between data packets. However, to be workable, the system, and in particular, the User Equipment (UE), which can be a mobile terminal, telephone, mobile station, laptop computer or the like, must obtain and maintain robust time and frequency synchronization. Without robust time and frequency synchronization, a local oscillator in the UE may drift between received packets resulting in missed or faulty data packets. Hence, what is desired in a UE is a method and apparatus adapted to perform robust automatic frequency correction (AFC).

AFC algorithms are known in the art and are used in GSM, WCDMA and OFDM systems such as Digital Video Broadcast—Handheld (DVB-H) and Wireless-Local Area Network (WLAN). Conventionally, there are two AFC algorithms that are used in OFDM. Both algorithms assume that time synchronization, i.e. the timing of OFDM symbols, are known. There are several known methods for obtaining time synchronization and hence these are not described in depth herein. For example, in 3G LTE, time synchronization can be obtained from the synchronization channel (SCH).

The first of the two algorithms relies on using the cyclic prefix (CP) introduced in OFDM to make OFDM robust against time dispersion. In this algorithm, referred to as the CP correlation algorithm, the OFDM symbol is correlated over the CP:

$${d}_{cp} ( n ) = \frac{1}{{N}_{cp}} {\sum }_{k = 1}^{{N}_{cp}} {x}_{k} {x}_{k + {τ}_{s}}^{*} \\ {D}_{cp} ( n ) = {λ}_{1} {D}_{cp} ( n - 1 ) + ( 1 - {λ}_{1} ) {d}_{cp} ( n ) , {λ}_{1} ∈ ( 0 , 1 ) \qquad ( 1 )$$

where x is the signal in the time domain, x* is the complex conjugate of the signal x, λ₁ is a constant that determines over how many signals to filter, N_{cp} is the length of the CP (in samples) and τₛ is the length of the OFDM symbol. Furthermore n is the OFDM symbol index, and hence the CP correlation is averaged over a number of OFDM symbols. An estimate of the frequency error can then be obtained from the angle of D (assuming the radio channel is constant over the entire OFDM symbol):

$${\hat{f}}_{err} = \frac{arg {D}_{cp}}{2 π {τ}_{s}} \qquad ( 2 )$$

The second algorithm, referred to as the pilot symbols algorithm, is based on performing the same type of correlation but in the frequency domain, following Fast Fourier Transform (FFT), using pilot symbols:

$${d}_{pilot} ( n ) = {\sum }_{i ∈ pilotcarriers} {X}_{n , i} {X}_{n + k , i}^{*} \\ {D}_{pilot} ( n ) = {λ}_{2} {D}_{pilot} ( n - 1 ) + ( 1 - {λ}_{2} ) {d}_{cp} ( n ) , {λ}_{2} ∈ ( 0 , 1 ) \\ {\hat{f}}_{err} = \frac{arg {D}_{pilot}}{2 π {τ}_{n}} \qquad ( 3 )$$

where X_{n,i} is the pilot symbol at sub-carrier i at time n, X*_{n+k,i} is the complex conjugate of the pilot symbol at sub-carrier i at time n+k k is the number of symbols between two pilot symbols on carrier i, λ₂ is a constant that determines over how many symbols to filter, and τₙ is the time between pilots on the same sub-carrier. The advantage of using the CP correlation algorithm over the pilot symbols algorithm is that CP correlation provides a higher Nyquist frequency, making the CP correlation algorithm more robust against Doppler spreading. However, if the frequency error is small, the rotation during an OFDM symbol is also small making the estimate more sensitive to noise compared to the pilot symbols algorithm. In any event, potential problems arise using either of these algorithms in a 3G LTE system. In order to use 3G LTE in the current WCDMA spectrum, a 3G LTE system should be able to operate in a reuse one fashion as is done in WCDMA. This implies that the SNR at the cell border could be well below 0 dB. However, 3G LTE does not use spreading codes and therefore has less processing gain resulting in a lower ability to suppress noise. This directly affects the frequency synchronization algorithms, increasing the need for long term averaging (larger λ) in order to suppress the noise. Because more time is required to average in order to obtain a satisfactory frequency estimate, the UE must be in awake mode longer in the VoIP scenarios. As a result, the DRXIDTX periods will become much shorter, increasing the current consumption of the UE.

### SUMMARY

This present invention is an adaptive frequency estimation method, and apparatus implementing the method, that adapts, from time to time, between the CP correlation algorithm and pilot symbols algorithm, depending on the values of several variables, including service (VoIP/high data rate), signal to noise ratio (SNR), Doppler spread, system BW, and whether the system is time division duplex (TDD) or frequency division duplex (FDD). The method and apparatus is also adapted to select both algorithms. Furthermore, depending on the values of such variables, the UE determines, in accordance with the present invention, whether frequency estimates are based only on the serving/camping cell (active/idle mode) or if other detected cells (detected by the cell searcher, and used as potential handover (HO) candidates) should be used. This is typically the case at the cell border where the SNR can be improved significantly if more than one cell (for instance, using the CP correlation algorithm) is used for frequency error correction.

### BRIEF DESCRIPTION OF THE SEVERAL VIEWS OF THE DRAWINGS

In the following section, the invention will be described with reference to exemplary embodiments illustrated in the figures, in which:

FIG. 1 is a flow chart of the method of the present invention; and

FIG. 2 is a block diagram of an apparatus adapted to implement the method of the present invention.

### DETAILED DESCRIPTION

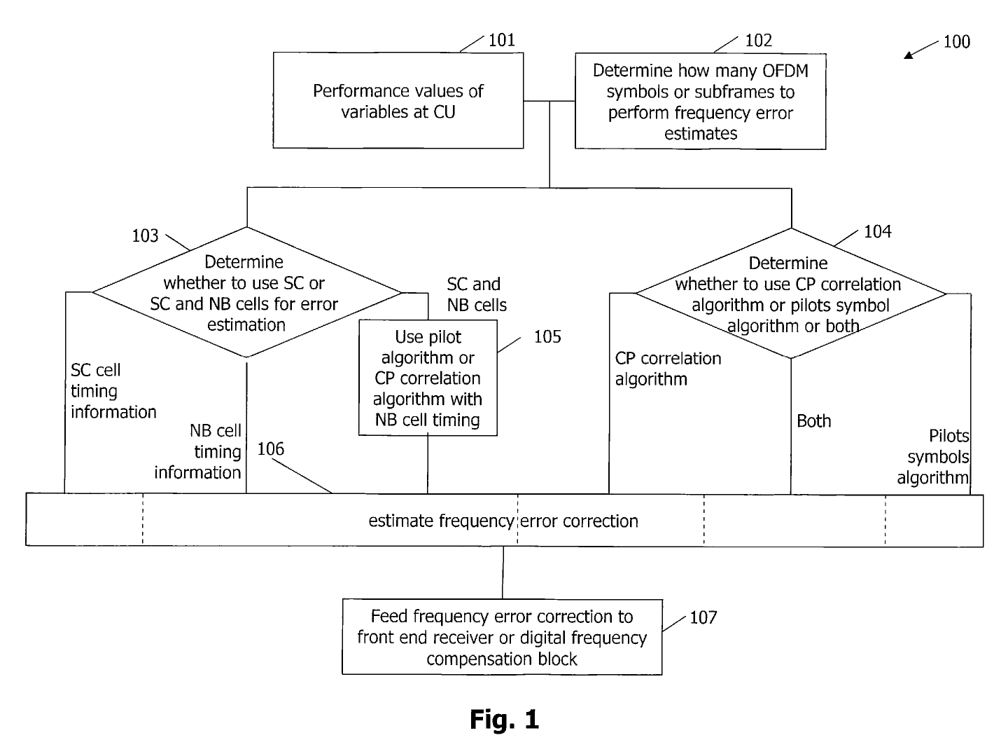

A flow chart 100 of the method of the present invention can be seen in FIG. 1. As seen therein, in step 101, values of several variables are sent to or are calculated by a control unit (CU) of a User Equipment (UE). Such variables include current service, such as VoIP and low power mode/high data rate, continuous reception, Doppler spread, whether there is a line-of sight channel, as determined in a channel estimator unit, system BW, being 1.25 to 20 MHz in a 3G LTE system, and whether TDD or FDD is used. In step 102, the CU determines how many OFDM symbols or subframes over which to perform frequency error estimates (i.e. the value of λ). Based on the values of the variables, in steps 103 and 104, a CU determines decision whether to use only a serving cell (SC) for frequency error estimates or the SC and also neighboring (NB) cells, and also whether to use the CP correlation algorithm (1)) or frequency error detection based on pilot symbols algorithm (3), or a combination of these algorithms. In step 105, if the CU determines to use the NB cells for AFC, it can either use the pilot symbols algorithm, and hence perform the FFT using the NB cell timing or use the CP correlation algorithm and hence perform the CP correlation using NB cell timing. In step 106, the frequency error is estimated. In step 107, a combined estimated frequency error is fed back to the analog front end of the UE and the local oscillator frequency of the UE is adjusted. Alternatively, in step 107, a digital frequency compensation block can perform the frequency error correction.

In the case where the UE is in idle mode, the UE is not connected to a SC. In that case, the UE camps on one cell, is activated at regular time intervals, and performs paging detection from that cell. However, the method of the present invention can still be performed as described above. In that case, the UE, based on a number of parameters, determines which AFC algorithm is to be used and whether only the cell the UE is camping on or any other detected NB cells should be included in making frequency error estimates.

The following sets forth a number of examples of how the CU determines which AFC algorithms are to be used and if only SC or camping cells alone or with NB cells should be included in the frequency error estimation. Such determination can be made, for example, using software executed by a hardware portion of the CU.

TDD/FDD and SNR. In TDD, which is where up-link and down-link are time multiplexed on the same carrier. As a result, the cells must be synchronized, that is all cells need to be time aligned within approximately the cyclic prefix. In this case, the UE only needs to perform CP correlation for the SC as all other cells are time synchronized and therefore are implicitly, coherently added in the CP correlation from the SC. Hence, the effective SNR will be high. For high SNRs, only the SC is needed and thus the use of the CP correlation algorithm is preferred. This is also applicable to synchronized FDD systems. For a non-synchronized FDD system, the SNR could be very low at the cell border. Hence, for low SNR (e.g., less than 0 dB) there will be an advantage to using the detected NB cells for frequency error estimation.

Doppler. If the UE is in motion such that the channel experiences high Doppler spread, the CP correlation algorithm is more effective than the pilot symbols algorithm, due to the higher Nyquist frequency achieved. However, for very high Doppler spread and a line-of-sight channel where the Doppler spread starts to behave similar to a frequency error, the frequency error estimate could be different for different cells. Hence, when a high Doppler spread and line-of-sight is detected, the UE would use the frequency error estimate only from the SC. However, the frequency error for NB cells should also be estimated, but not combined, in order to obtain a fast frequency error estimate for the new cell in the event of a handover.

Service. As noted above, when the service is VoIP, DRX/DTX is often being used. In DRX/DTX, there is a potential for frequency drift due to the cooling and heating of components within the UE that occurs when turning the receiver and transmitter on and off. Because a high Nyquist frequency is desirable, use of the CP correlation algorithm is preferable. However, with high data rates and during continuous reception there is less frequency drift from heating and cooling cycles, such that the pilot symbols algorithm is preferable for frequency error estimation.

System BW. In 3G LTE, the CP is 4.7 microseconds (μs) regardless of the BW. Hence, the effective number of CP samples is 16 times smaller for a BW that is 1.25 MHz compared to a BW that is 20 MHz. As a result, the coherence gain in averaging over the CP is much smaller for 1.25 MHz compared to 20 MHz. Therefore, in the low BW scenario, it is preferable to use pilot symbols algorithm for estimating the frequency error.

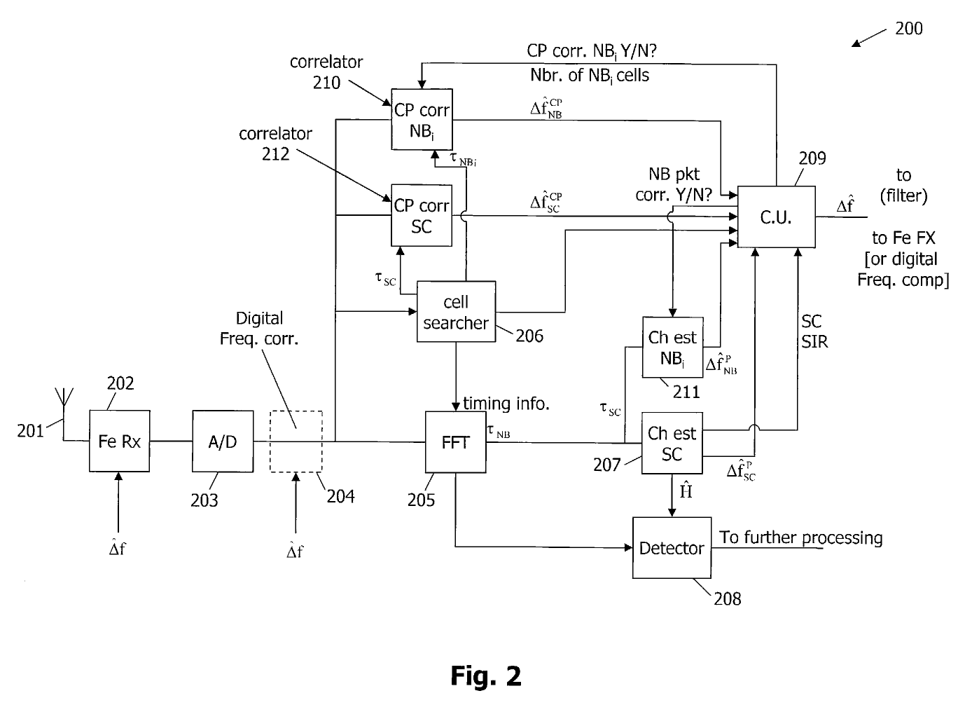

FIG. 2 is a block diagram 200 of an apparatus that is adapted to implement the method of the present invention as described above. FIG. 2 initially assumes that the UE is in active mode such that it has a connection with a SC and is in synchronization with the SC. The idle mode case is described later.

As seen therein, the signal is received at antenna 201 and down converted to a baseband signal in the front end receiver (Fe RX) 202. The signal is converted from analog to digital form at A/D unit 203. Digital frequency correction (as described in more detail below) occurs at digital frequency correction module 204. The signal is then provided from A/D unit 203 to Fast Fourier Transform (FFT) unit 205 and the cell search (CS) unit 206. CS unit 206 correlates the SC SCH signal to the received signal at regular intervals in order to maintain the time synchronization, τ_{SC}, which is the time instant the FFT signal should be sampled (CP correlator SC unit 212). The CS unit 206 also, at regular time intervals, searches for new NB cells to be used as potential HO candidates. For all detected NB cells, the timing information, τ_{NB}_{ᵢ} associated therewith are stored and updated regularly at CP correlator NBi unit 210.

The signal from the FFT unit 205 is provided to the SC channel estimation unit 207 where the channel and the SIR are estimated using the known pilot symbols. That information is then used in detector unit 208 to detect the data, as is known in the art. The SIR is fed to CU 209 that also receives information about current service (e.g., VoIP and low power mode/high data rate, continuous reception), Doppler spread and whether there is a line-of sight channel (determined in the channel estimator unit 207), system BW (1.25 to 20 MHz if 3G LTE) and whether TDD or FDD is being used. Based on these parameters, the CU 209 determines whether to use only the SC for frequency error estimates or use SC and NB cells for frequency error estimates, and also whether to use the CP correlation algorithm or the pilot symbols algorithm, or a combination of these algorithms. Also, the number of OFDM symbols or subframes over which to perform frequency error estimates to obtain the value of λ are determined by CU 209. If it is determined that the pilot symbols for NB cells should be used for AFC, the FFT signal must also be processed using the NB cell timing, so long as the NB cell(s) are not time aligned with the SC. The combined estimated frequency error is then fed back to the Fe Rx 202 and the local oscillator frequency therein is adjusted accordingly. In another embodiment of the present invention, digital frequency compensation block 204 performs the frequency error correction.

As noted above, when the UE is in idle mode, the UE is not connected to a SC. In that case, the UE camps on one cell, is activated at regular time intervals, and performs paging detection from that cell. However, the apparatus of the present invention is still adapted to perform the operations described above. In that case, the UE, based on a number of parameters, determines which AFC algorithm is to be used and whether only the cell the UE is camping on or any other detected NB cells should be included in making frequency error estimates.

As noted with respect to the method of the present invention, the values to a number of parameters are obtained by, or determined by, CU 209 and operated upon in order to determine which AFC algorithms are to be used and if NB cells should be included in the frequency error estimation. The parameters include, among others, TDD/FDD, SNR, Doppler spread, service, and system BW. The apparatus of the present invention is adapted to operate upon such parameters in accordance with the method of the present invention.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method of estimating frequency error in an UE, comprising the steps of:
receiving a signal by the UE;
determining or obtaining by the UE the value of at least one parameter from the group consisting of: system bandwidth (BW); the service being used; Signal to Noise Ratio (SNR) on a serving cell (SC); SNR on a camping cell; Doppler spread; and whether the system is frequency division duplex (FDD) or time division duplex (TDD); and
based on the value of at least one of the parameters, estimating by the UE the frequency error of the received signal from either (1) a SC or camping cell alone or (2) a SC or camping cell and at least another cell which the UE has detected as a neighboring (NB) cell.

2. The method of claim 1, further comprising the step of estimating the frequency error using a cyclic prefix (CP) correlation algorithm, based on the value of at least one of the parameters.

3. The method of claim 2, wherein CP correlation algorithm is represented by:
$${d}_{cp} ( n ) = \frac{1}{{N}_{cp}} {\sum }_{k = 1}^{{N}_{cp}} {x}_{k} {x}_{k + {τ}_{s}}^{*}$$
$${D}_{cp} ( n ) = {λ}_{1} {D}_{cp} ( n - 1 ) + ( 1 - {λ}_{1} ) {d}_{cp} ( n ) , {λ}_{1} ∈ ( 0 , 1 )$$
where x is the signal in the time domain, x* is the complex conjugate of the signal x, λ₁ is a constant that determines over how many signals to filter, N_{cp} is the length of the CP (in samples), τₛ is the length on the OFDM symbol, n is the OFDM symbol index;
the CP correlation is averaged over a number of OFDM symbols;
an estimate of the frequency error is obtained from the angle of D (assuming the radio channel is constant over the entire OFDM symbol); as follows:
$${\hat{f}}_{err} = \frac{arg {D}_{cp}}{2 π {τ}_{s}}$$

4. The method of claim 1, further comprising the step of estimating the frequency error from an SC or camping cell alone using a CP correlation algorithm, when the SNR is high.

5. The method of claim 1, further comprising the step of estimating the frequency error from an SC or camping cell alone using a CP correlation algorithm, based on the up-link and down-link of a system used by the UE being time multiplexed.

6. The method of claim 1, further comprising the step of estimating the frequency error from an SC or camping cell alone using a CP correlation algorithm based on the UE determining that the system uses TDD.

7. The method of claim 1, further comprising the step of estimating the frequency error from an SC or camping cell alone using a CP correlation algorithm based on the UE determining that the system uses synchronized FDD.

8. The method of claim 1, further comprising the step of estimating the frequency error using a CP correlation algorithm based on the UE determining a high Doppler spread.

9. The method of claim 8, further comprising the step of estimating the frequency error using an SC or camping cell alone.

10. The method of claim 9, further comprising the step of estimating the frequency error using an SC or camping cell alone when the UE has determined that the channel is line-of-sight.

11. The method of claim 8, further comprising estimating, but not combining, by the UE, the frequency error for NB cells so as to obtain a fast frequency error estimate for a new cell in the event of a handover.

12. The method of claim 1, further comprising the step of estimating the frequency error from an SC or camping cell alone using a CP correlation algorithm when the UE has determined that discontinuous reception/discontinuous transmission (DRX/DTX) is being used.

13. The method of claim 1, further comprising the step of estimating the frequency error from an SC or camping cell alone using a CP correlation algorithm when the UE has determined that VoIP is being used.

14. The method of claim 1, further comprising the step of estimating the frequency error using a CP correlation algorithm when the UE has determined that the BW is wide.

15. The method of claim 1, further comprising the step of estimating the frequency error from an SC or camping cell alone using a CP correlation algorithm when the UE has determined that the BW is high.

16. The method of claim 1, further comprising the step of estimating the frequency error from a SC or camping cell and at least another cell which the UE has detected as a neighboring (NB) cell when the UE determines that the SNR is low.

17. The method of claim 16, further comprising the step of estimating the frequency error from a SC or camping cell and at least one other cell which the UE has detected as a neighboring (NB) cell when the UE determines that the SNR is less than 0 dB.

18. The method of claim 1, further comprising the step of estimating the frequency error from a SC or camping cell and at least one other cell which the UE has detected as a neighboring (NB) cell when the UE determines that the system is a non-synchronized FDD system.

19. The method of claim 1, further comprising the step of estimating the frequency error using a pilot symbols algorithm, based on the value of at least one of the parameters.

20. The method of claim 19, wherein the pilot symbols algorithm is represented by:
$${d}_{pilot} ( n ) = {\sum }_{i ∈ pilot carriers} {X}_{n , i} {X}_{n + k , i}^{*}$$
$${D}_{pilot} ( n ) = {λ}_{2} {D}_{pilot} ( n - 1 ) + ( 1 - {λ}_{2} ) {d}_{cp} ( n ) , {λ}_{2} ∈ ( 0 , 1 )$$
$${\hat{f}}_{err} = \frac{arg {D}_{pilot}}{2 π {τ}_{n}}$$
where X_{n,i} is the pilot symbol at sub-carrier i at time n, X*_{n+k,i} is the complex conjugate of the pilot symbol at sub-carrier i at time n+k k is the number of symbols between two pilot symbols on carrier i λ₂ is a constant that determines over how many symbols to filter and τₙ is the time between pilots on the same sub-carrier.

21. The method of claim 19, comprising the step of estimating the frequency error using a pilot symbols algorithm, based on the UE detecting high data rates.

22. The method of claim 19, comprising the step of estimating the frequency error using a pilot symbols algorithm, based on the UE detecting a narrow BW.

23. The method of claim 19, further comprising the step of estimating the frequency error from a SC or camping cell and at least another cell which the UE has detected as a neighboring (NB) cell when the UE determines that the SNR is low.

24. The method of claim 19, further comprising the step of estimating the frequency error from a SC or camping cell and at least one other cell which the UE has detected as a neighboring (NB) cell when the UE determines that the SNR is less than 0 dB.

25. The method of claim 19, further comprising the step of estimating the frequency error from a SC or camping cell and at least one other cell which the UE has detected as a neighboring (NB) cell when the UE determines that the system is a non-synchronized FDD system.

26. The method of claim 1, for use in an OFDM system.

27. The method of claim 26, wherein the OFDM system is a 3G LTE system.

28. The method of claim 26 wherein the OFDM system is a WIMAX system.

29. A method of estimating frequency error in a user equipment (UE), comprising the steps of:
receiving a signal by the UE;
determining or obtaining by the UE the value of at least one parameter from the group consisting of: system bandwidth (BW); the service being used; signal to noise ratio on a serving cell (SC); SNR on a camping cell; Doppler spread; and whether the system is frequency division duplex (FDD) or time division duplex (TDD); and
based on the value of at least one of the parameters, estimating frequency error of the received signal from either (1) a SC or camping cell alone or (2) a SC or camping cell and at least another cell which the UE has detected as a neighboring (NB) cell; and
estimating frequency error of the received signal using either (1) a cyclic prefix (CP) correlation algorithm, based on the value of at least one of the parameters or (2) a pilot symbols algorithm, based on the value of at least one of the parameters, or combination of the algorithms based on the value of at least one of the parameters.

30. An apparatus in an user equipment (UE) for estimating frequency error, comprising:
a means for receiving a signal by the UE;
a means for determining or obtaining by the UE the value of at least one parameter from the group consisting of: system bandwidth (BW); the service being used; signal to noise ratio on a serving cell (SC); Signal to Noise Ration (SNR) on a camping cell; Doppler spread; and whether the system is frequency division duplex (FDD) or time division duplex (TDD); and
based on the value of at least one of the parameters, a means for estimating by the UE frequency error of the received signal from either (1) a SC or camping cell alone or (2) a SC or camping cell and at least another cell which the UE has detected as a neighboring (NB) cell.

31. The apparatus of claim 30, further comprising a means for estimating the frequency error using a cyclic prefix (CP) correlation algorithm, based on the value of at least one of the parameters.

32. The apparatus of claim 30, further comprising a means for estimating the frequency error from an SC or camping cell alone using a CP correlation algorithm, when the SNR is high.

33. The apparatus of claim 30, further comprising a means for estimating the frequency error from an SC or camping cell alone using a CP correlation algorithm, based on the up-link and down-link of the system used by the UE being time multiplexed.

34. The apparatus of claim 30, further comprising a means for estimating the frequency error from an SC or camping cell alone using a CP correlation algorithm based on the UE determining that the system uses TDD.

35. The apparatus of claim 30, further comprising a means for estimating the frequency error from an SC or camping cell alone using a CP correlation algorithm based on the UE determining that the system uses synchronized FDD.

36. The apparatus of claim 30, further comprising a means for estimating the frequency error using a CP correlation algorithm based on the UE determining a high Doppler spread.

37. The apparatus of claim 30, further comprising a means for estimating the frequency error using an SC or camping cell alone.

38. The apparatus of claim 37, further comprising a means for estimating the frequency error using an SC or camping cell alone when the UE has determined that the channel is line-of-sight.

39. The apparatus of claim 30, further comprising a means for estimating, but not combining, by the UE, the frequency error for NB cells so as to obtain a fast frequency error estimate for a new cell in the event of a handover.

40. The apparatus of claim 30, further comprising a means for estimating the frequency error from an SC or camping cell alone using a CP correlation algorithm when the UE has determined that discontinuous reception/discontinuous transmission (DRX/DTX) is being used.

41. The apparatus of claim 30, further comprising a means for estimating the frequency error from an SC or camping cell alone using a CP correlation algorithm when the UE has determined that VoIP is being used.

42. The apparatus of claim 30, further comprising a means for estimating the frequency error using a CP correlation algorithm when the UE has determined that the BW is wide.

43. The apparatus of claim 30, further comprising a means for estimating the frequency error from an SC or camping cell alone using a CP correlation algorithm when the UE has determined that the BW is high.

44. The apparatus of claim 30, further comprising a means for estimating the frequency error from a SC or camping cell and at least another cell which the UE has detected as a neighboring (NB) cell when the UE determines that the SNR is low.

45. The apparatus of claim 44, further comprising a means for estimating the frequency error from a SC or camping cell and at least another cell which the UE has detected as a neighboring (NB) cell when the UE determines that the SNR is less than 0 dB.

46. The apparatus of claim 30, further comprising a means for estimating the frequency error from a SC or camping cell and at least another cell which the UE has detected as a neighboring (NB) cell when the UE determines that the system is a non-synchronized FDD system.

47. The apparatus of claim 30, wherein the means for determining or obtaining by the UE the value of at least one parameter comprises a control unit (CU).

48. The apparatus of claim 47, wherein the control unit comprises a hardware unit operable to execute software instructions.

49. The apparatus of claim 47, wherein the means for estimating frequency error comprises a channel estimation unit.

50. The apparatus of claim 49, further comprising a means for correcting the frequency error in a front end receiver.

51. The apparatus of claim 47, further comprising a digital frequency compensation block adapted to correct the frequency error.

52. The apparatus of claim 30, further comprising a means for estimating the frequency error using a pilot symbols algorithm, based on the value of at least one of the parameters.

53. The apparatus of claim 52, further comprising a means for estimating the frequency error using a pilot symbols algorithm, based on the UE detecting high data rates.

54. The apparatus of claim 52, further comprising a means for estimating the frequency error using a pilot symbols algorithm, based on the UE detecting a narrow BW.

55. The apparatus of claim 30, for use in an OFDM system.

56. The apparatus of claim 55, wherein the OFDM system is a 3G LTE system.

57. The apparatus of claim 55 wherein the OFDM system is a WIMAX system.
